(19) United States
(12) Patent Application Publication
(10) Pub. No.: US 2003/0005455 A1
(43) Pub. Date: Jan. 2, 2003

(54) Aggregation of streaming media to improve network performance

(76) Inventor: J. Rob Bowers, Saratoga, CA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 09/896,733

(22) Filed: Jun. 29, 2001

(51) Int. Cl. H04N 7/173

(52) U.S. Cl. 725/90; 725/94; 725/131; 725/119; 725/118

(57) ABSTRACT

A system for maintaining the data rate of receivers to a network as requested media is delivered to one or more of the receivers. The system includes a proxy module acting as a single portal through which media requests are delivered to the network. The proxy module retrieves a stream of the requested media and delivers the media to the aggregation module for distribution and bookkeeping. The aggregation module retrieves and caches or buffers the stream of requested media from the proxy module. The aggregation module generates one or more media streams deliverable to the requesting receivers, such streams being receiver specific streams or non-receiver specific streams. The aggregation module can also deliver the requested media to the receivers upon an unused video and/or audio channel available to the receiver.

### BACKGROUND OF THE INVENTION

1. The Field of the Invention

The present invention generally relates to managing the delivery of media to set top boxes in a network, and more specifically relates to methods and systems for limiting the negative effects upon the network connectivity performance of set top boxes or other network connected interfaces when streaming media is requested by one or more of the set top boxes or other network connected interface.

2. Background and Related Art

In recent years, the Internet has expanded into the activities of individuals and businesses alike. A great wealth of information and entertainment is easily available upon accessing the Internet. Access of such information and resources can be achieved through a variety of different manners, such as via an Internet Service Provider (ISP), direct link to the Internet backbone or infrastructure, or the like.

With the advances in technology in recent years and the availability of cable and satellite infrastructure, many cable or satellite television operators provide Internet access along with typical television programming. In this manner, the cable and/or satellite operators provide a greater number of entertainment, informational, and educational materials and resources than is available with only the cable and/or satellite programming.

Typically, a cable system includes a Cable Modem Termination System (CMTS) that converts cable modem data into data packets transferable in the Internet environment, and vice versa. Similarly, a satellite system includes a modem termination system that facilitates delivery of data packets. Unfortunately, many existing cable or satellite modem systems are adversely affected by the transmission of large quantities of data within a short time period, such as the case with the transmission of streaming audio or video programming or media.

Delivery of streaming media or other continuous media, particularly real-time or recorded audio and/or video, in a cable or satellite system can have a huge impact on the performance of the Internet services provided by the cable or satellite systems. Specifically, a large bandwidth is required to deliver streaming media with reasonable quality. In a shared network, such as cable or satellite systems that provide Internet connectivity, viewers or users of the cable or satellite system may be adversely affected when video or audio programming is “streamed” to one or more set top boxes within the cable or satellite system. The viewers of the streaming media often receive an interrupted playback of requested media, resulting in a perception that the service provider is substandard. Similarly, a user of the shared network who is visiting various Internet sites, or “surfing,” the World Wide Web (the “Web”) may watch his Internet connection slow to a crawl because of the heavy traffic in the shared network. This results in the user perceiving that the service provider is substandard.

Typically, existing cable or satellite systems that provide Internet connectivity, such as the system designated by reference numeral 10 in FIG. 1, enable communication between a receiver module 20b, such as a set-top box or other similar Internet capable receiver, and one or more servers 12a-12n through Internet 14. As illustrated, by the solid arrows, existing systems utilize a one-to-one connection between receiver module 20b and the particular data termination system 18, such as a cable modem or satellite modem termination system. Additionally, there is a one-to-one relationship between the communication between data termination system 18, proxy server 16, and Internet 14.

Each time a viewer uses receiver module 20a-20n or other Internet compliant electronics devices to retrieve media or data from servers 12a-12n, additional connections are made between data termination system 18, proxy server 16, and Internet 14. By adding extra connections to Internet 14, the available network resources of proxy server 16 is reduced.

Consequently, the quantity of data delivered to receiver modules 20-20n is reduced and there is a perceived slowing of each user's connection with Internet 18. The slowing of connectivity is exacerbated when one or more receiver modules 20a-20n request streaming media from servers 12a-12n.

### SUMMARY OF THE INVENTION

To overcome the limitations associated with multiple receivers requesting and receiving real-time streaming or continuous media or data via the Internet, disclosed herein are systems and methods for providing such media or data from a wide area network to a plurality of receivers without affecting the connection performance of the other receivers within the same shared network. Additionally, disclosed herein are systems and methods for optionally identifying a particular manner to deliver the requested real-time streaming or continuous media or data to one or more receivers that request such media or data.

To overcome the problems with existing cable or satellite modem systems, the present invention provides for a special service to the proxy module that communicates with the Internet over a single communication stream. This special service, incorporated within an aggregation module, acts as a single portal through which all requests for real-time streaming or continuous media or data from set top boxes or receivers within a shared network are checked for duplication. The aggregation module, subsequently, delivers a single request to the proxy server, which in turn makes a single request for the stream to the Internet, and subsequently to those servers, source modules, or other data repositories containing or storing the media or data.

In response to a request for real-time streaming or continuous media or data, such as streaming audio or video media, the aggregation module retrieves the requested media stream from the proxy module, buffers the media stream, and subsequently delivers the media to one or more set top boxes located at the viewer's home, business, or the like. Although the aggregation module can receive multiple requests from multiple set top boxes, embodiments of the present invention can maintain a single communication stream with the proxy module and subsequently the Internet, while providing one or more real-time streaming or continuous streams of media or data back to the set top boxes or receivers connected to the shared network.

According to another embodiment of the present invention, the proxy module delivers the above single stream to the aggregation module, which is configured to deliver requested real-time streaming or continuous media to one or more receiver modules via a multicast delivery technique. Generally, the aggregation module is configured to receive multiple requests for streaming media and aggregate the requests into a single stream request deliverable to the proxy module. The aggregation module is also configured to receive a single stream of media from the proxy module and generate a multicast stream deliverable to the set top boxes that made the media requests. Embodiments of the present invention, therefore, deliver shared data packets or receiver specific packets of streaming media, where each packet is designated for a particular set top box or receiver.

The aggregation module can automatically identify the manner by which the received real-time streaming or continuous media or data is to be delivered to the receiver modules of the shared network. For instance, the aggregation module can deliver shared data packets or receiver specific data packets to the set top boxes or receivers of the shared network. Alternatively, an administrator and/or network operator can manually identify the manner by which the streaming media or data are delivered to the receiver modules of the shared network. In another embodiment, the system of the present invention uses a combination of both automatic and manual identification and determination of the manner by which the streaming media or data is delivered to the set top boxes or receivers connected to the network.

According to another embodiment of the present invention, the system includes a conversion module. The conversion module, whether alone or in combination with the proxy module and/or the aggregation module, provides the requested real-time streaming or continuous media or data upon an unused video and/or audio channel, either as television video or audio or via other methods including but not limited to SCA encoding, available to the set top box or receiver. This is in contrast to delivering the requested real-time streaming or continuous media or data to the set top boxes or receivers using packetized Internet data. Consequently, the individual requesting the streaming media or data can be notified of the availability of the streaming media or data upon an unused video and/or audio channel or automatically switched from the currently displayed video and/or audio media to the particular channel where the streaming media is to displayed. In this manner, the bandwidth of the video and/or audio channel is used to deliver the streaming media to the set top box or receiver and the requested streaming media or data is released for other uses in the particular communication line connection typically used to deliver the media or data.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a prior art system for delivering Internet data to one or more set top boxes or receivers.

FIG. 2 illustrates an exemplary system of one embodiment of the present invention.

FIG. 3 illustrates a receiver module in the exemplary system of the embodiment of the present invention depicted in FIG. 2.

FIG. 4 illustrates a more detailed representation of one embodiment of an access module that is capable of aggregating requests for real-time streaming or continuous media in accordance with one embodiment of the present invention depicted in FIG. 2.

FIG. 5 is a flow diagram illustrating one exemplary method for requesting and receiving media or data using the access module of the present invention depicted in FIG. 4.

FIG. 6 illustrates another embodiment of an access module that is capable of aggregating requests for real-time streaming or continuous media and delivering the media to one or more receiver modules via a multicast process in accordance with another embodiment of the present invention depicted in FIG. 2.

FIG. 7 is a flow diagram illustrating one exemplary method for requesting and receiving media or data using the access module of the present invention depicted in FIG. 6.

FIG. 8 illustrates yet another embodiment of an access module that is capable of aggregating requests for real-time streaming or continuous media and delivering the media to one or more receiver modules via an unused channel associated with the receiver module in accordance with the another embodiment of the present invention depicted in FIG. 2.

FIG. 9 is a flow diagram illustrating one exemplary method for requesting and receiving media or data using the access module of the present invention depicted in FIG. 8.

### DETAILED DESCRIPTION OF THE INVENTION

The present invention extends to systems and methods for controlling delivery of real-time streaming media, including but not limited to, live webcasts, and internet radio streams or other continuous media to one or more set top boxes or receivers that request to receive such real-time streaming or continuous media. Further, the systems and methods of the present invention relate to communication of set top boxes or receivers and data termination systems, such as a cable modem termination system or equivalent termination system associated with a satellite system, fiber optic system, or the like in a wide area or local area network. The methods and systems of the present invention substantially reduce the effects upon set top boxes or receivers connected to the data termination system as streaming media or other continuous media or data is delivered to one or more of the set top boxes or receivers. For instance, embodiments of the present invention reduce or eliminate the effects upon connection performance of the shared network upon a large number of set top boxes or receivers requesting and receiving real-time streaming or continuous media. Consequently, embodiments of the present invention control access to media or data deliverable from the Internet to the set top boxes or receivers connected to a shared network of a cable system, satellite system, fiber optic communication system, or the like.

In addition to the above, embodiments of the present invention enable delivery of media or data, such as streaming media, i.e., video and audio, or other continuous media, i.e., stock quotes, news, and other text streams, by a variety of different manners depending upon the current “traffic load” of the shared network. Stated another way, embodiments of the present invention can dynamically or heuristically vary the delivery methods of requested media based upon the number of set top boxes or receivers that request such media and the particular bandwidth required to deliver such media. For instance, embodiments of the present invention can select to deliver independent streams of the streaming or continuous real-time media to each set top box or receiver requesting such real-time media or can delivery the same real-time media or data via a multicast broadcast. Further, embodiments of the present invention enable delivery of the requested real-time media via an unused video and/or audio channel of the cable or satellite system that provides Internet connectivity. By so doing, the embodiments of the present invention reduce the effects upon all set top boxes or receivers connected to the shared network when one or more streams of streaming media or other continuous media is delivered to one or more set top boxes or receivers. Consequently, embodiments of the present invention enable delivery of one or more streams of streaming media or other continuous media in a flexible manner that fits the requirements of the operator, as will be understood from the disclosure contained herein.

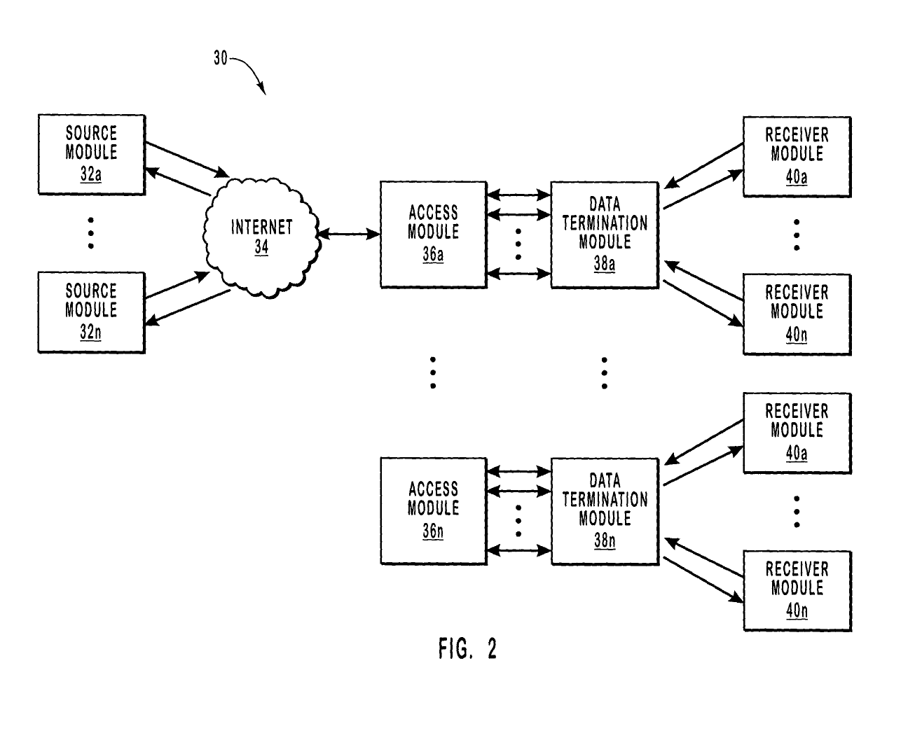

Referring now to FIG. 2, depicted is a schematic representation of a system, designated by reference numeral 30, which facilitates delivery of media, such as streaming media or other continuous media, to one or more set top boxes or receivers. As illustrated, system 30 includes source modules 32a-32n that are accessible via a network 34, such as but not limited to, a wide area network, a local area network, a wireless network, the Internet, or the like. Source modules 32a-32n can have various configurations, so long as they perform the general function of hosting web pages, web sites, etc., storing media or data, delivering media or data through network 34 to access modules 36a-36n, or the like, whether or not such media or data is “streamed” or “streaming” media or data.

The term “streaming” relates to the delivery of media or data in a manner that enables an application processing the media or data to do so in a steady and/or continuous manner. For instance, “streaming video” can be delivered in a steady stream so that a video playing application displays the video image in a continuous and uninterrupted manner. Further, the terms “media” and “data” refer to any type of audio, video, text, graphics, or combinations thereof that are deliverable by packets, signals, or the like between a source and a receiver, such as a set top box. For instance, the terms “media” or “data” can include streaming audio or video, which is recorded or real-time. Additionally, the usage of the term “media” includes any associated “data” and the usage of the term “data” includes the associated “media.”

Facilitating communication between receiver modules 40a-40n and source modules 32a-32n through network 34 is access modules 36a-36n and data termination modules 38a-38n. The following discussion will focus on a single access module 36 and a single data termination module 38; however, a similar discussion can be made for multiple access modules and data termination modules.

Access module 36 is adapted to receive requests for media, such as streaming media, from receiver modules 40a-40n through data termination module 38. The requests are used to identify those source modules 32a-32n from which access module 36 can obtain the selected media, including the associated data. The access module 36 aggregates the requests for real-time or continuous streaming media or data and stores one or more lists of the media requested and the receiver modules 40a-40n requesting the media. These lists are optionally deleted when access module 36 has completed delivery of the media to the requesting receiver modules 40a-40n.

Additionally, access module 36 can retrieve the requested media and subsequently buffer and deliver the media to data termination module 38. Access module 36 can deliver independent streams of the retrieved media to each receiver module 40a-40n, multicast a single stream of the retrieved media, or optionally select to present the retrieved media upon an unused audio and/or video channel accessible by receiver modules 40a-40n. Access module 36 can optionally convert the received real-time or continuous streaming media or data from one data format to a standardized format readable by receiver modules 40a-40n.

Through performing aggregation of requests for real-time or continuous streaming media or data, buffering or caching of the stream and delivery by one or more of the delivery manners described above, access module 36 substantially reduces interrupted or jerky playback or poor quality of streaming media that results in a perception by those viewers that the service provider is substandard. Further, access module 36 can substantially reduce the effect upon those receiver modules 40a-40n used for “surfing” or otherwise accessing the Internet as the streaming media is delivered to other receiver modules 40a-40n within the shared network associated with access module 36 and data termination module 38. In this manner, the connection performance or connection rate for those users “surfing” the web using receiver modules 40a-40n is maintained at substantially the same rate as before delivery of streaming media to other receiver modules 40a-40n of the shared network.

To facilitate delivery of streaming or continuous media or data to receiver modules 40a-40n, system 30 includes data termination module 38. As illustrated, data termination module 38 is capable of manipulating data indicative of a viewer's request to access the media available on the Internet, etc. received from receiver modules 40a-40n. For instance, when receiver module 40a-40n is a set-top box, having Internet capabilities and associated cable modem hardware and/or software components, data termination module 38 can be adapted to convert the radio frequency data deliverable from receiver module 40a-40n into the appropriate data packets deliverable to access module 36. It can be appreciated by one skilled in the art, that data termination module 38 can deliver and manipulate signals from those receiver modules 40a-40n associated with a satellite system, or other systems known to those skilled in the art in light of the teaching contained herein.

Communicating with data termination module 38 are receiver modules 40a-40n. Each receiver modules 40a-40n or receiver can include one or more computers or set top boxes that are configured to communicate with the shared network associated with access module 36, i.e., the cable or satellite network associated with the cable or satellite modem that enables the receivers to connect with the Internet. These receiver modules 40a-40n need not include television screens or other similar devices cable of displaying cable or satellite broadcast programming, so long as they are capable of connecting to the shared network associated with access module 36.

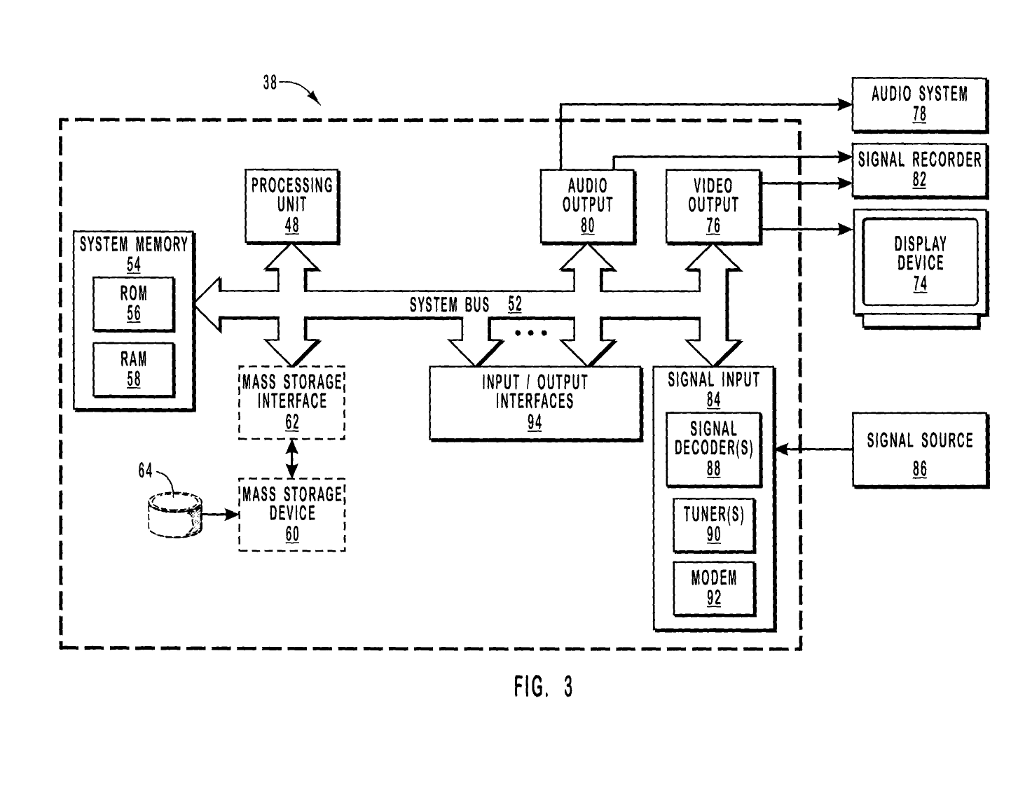

Referring now to FIG. 3, a schematic representation of one illustrative receiver module 40 is depicted. Generally, receiver module 40 can comprise a special purpose or general-purpose computer or special purpose processing device including various computer hardware and/or software known by one skilled in the art for receiving signals from a broadcast programming source or some other source for enhancing the capabilities of conventional televisions. Exemplary receiver module 40 can include a cable television box, a digital video broadcasting system (“DVB”), some other type of digital satellite system receiver (“DSS”), another type of set-top box with Internet capabilities.

As illustrated, receiver module 40 can include a central processing unit 48 that uses computer-executable instructions implemented in software and/or hardwired logic circuitry to perform various functions. These computer-executable instructions, such as program modules, cause receiving module 40a-40n to perform a certain function or group of functions. Generally, program modules can include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processing unit 48 can be coupled via a system bus 52, which also interconnects various other system components of receiver module 40a-40n. Processing unit 48 executes software designed to implement features of receiver module 40 including the features of the present invention. Processing unit 48 can contain circuitry that is used to implement certain functions of receiver module 40. Instructions, data, and other software used to operate processing unit 48 can be stored in a system memory 54, such as read-only memory (“ROM”) 56 and/or in random-access memory (“RAM”) 58. Optionally, receiver 40a-40n can include any mass storage device 60, which is coupled to a mass storage interface 62, as illustrated in dotted lines. ROM 56, RAM 58 and mass storage device 60 are communicatively coupled to processing unit 48 so as to be readable by processing unit 48 and so that data may be written from processing unit 48 to RAM 58 and possibly mass storage device 60.

Optional mass storage device 60 can be a magnetic hard disk 64 or any other magnetic, optical, or other mass memory device that is capable of storing data. Any desired computer-readable instructions or data, including application programs and other program modules can be stored in mass storage device 60. Mass storage device 60 is one structure capable of performing the function of a computer-readable media for carrying or having computer-executable instructions or data structures stored thereon. In addition, Mass Storage device 60 may be used to store and retrieve received media content, such as a media stream or other data delivered to the receiver. This computer-readable media can be any available media that can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to receiver module 40a-40n or some remote computer, both the receiver module 40a-40n and remote computer, such as but not limited to source modules 32a-32n, properly view the connection as a computer-readable medium. Thus, such a connection is also properly termed a computer-readable medium. Combinations of the above should also be included within the scope of computer-readable media.

As illustrated, receiver module 40a-40n communicates with a display device 74, such as a television display, a flat panel display, a projection display, a computer monitor, or any other device capable of displaying viewable image data, through a video output 76 and variety of different communication line connections known to one skilled in the art in light of the teaching contained herein. Additionally, receiver module 40a-40n can communicate with an audio system 78, such as one or more speakers for emitting sound data through an audio output 80 and/or a signal recorder 82, such as a video cassette recorder (“VCR”), capable of receiving video and/or audio data through video output 76 and audio output 80 and recording the data on a storage medium.

The receiver module 40a-40n can include a signal input 84, which receives programming channels from one or more signal sources 86. These signal sources 86 deliver single or multiple channels of programming to signal input 84 via one or more different communication line connections, known to one skilled in the art, such as but not limited to electromagnetic radiation connection, such as wireless, UHF, VHF, microwave transmission, or the like, cable connection, or optic connection. For purposes of this description and in the claims, the term “programming” includes both the viewable portions of moving image data and its associated sound data, whether delivered from a single channel source, such as video cassette, digital video disc, or the like or from a multi channel source, such as DSS/DVB, a cable box, or the like.

According to another aspect, signal input 84 can include one or more tuners 90 capable of tuning to the programming channels deliverable by signal source 86. Additionally, signal input 84 can include one or more signal decoders 88 optionally configured to (i) decipher the audio and/or video data representative of the programming channels received from signal source 86, (ii) convert the data from an analog format to digital format, and vice versa, and (iii) decompress the audio and/or video data received from signal source 86.

According to another aspect of the present invention, signal input 84 includes a modem 92 that translates the digital signaling from the signal source 86 into locally readable/executable internet content, including but not limited to: HTML, XML, Streaming Media formats and other common “Web” encoding methods enables receiver module 40a-40n to display Web pages including text, graphics and other static media/data and streaming media or other continuous media from remote sources,. In such a case, signal source 86 can have the form of a remote computer, which forms part of the Internet or some other wide area network or local area network.

Further, receiver module 40a-40n includes various input/output interfaces 94 that enable a user, consumer electronic devices, signal sources, or other suitable electronic devices to deliver and receive data or information therebetween. For instance, illustrative input/output interfaces include but are not limited to serial port interface, parallel port interface, infra-red interfaces, wireless interfaces, a universal serial bus (USB), Small Computer System Interface (SCSI), or the like.

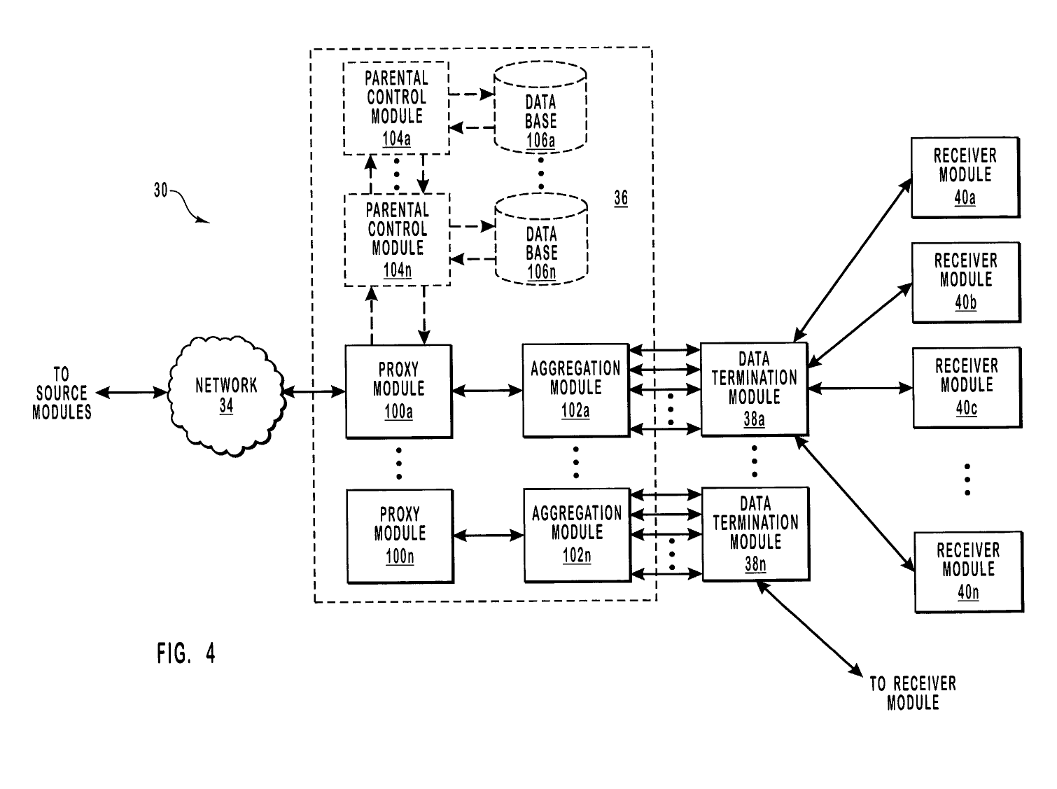

Referring now to FIG. 4, depicted is a more detailed representation of system 30 of one embodiment of the present invention. Specifically, a more detailed illustration of access module 36 is depicted. As shown, access module 36 includes proxy module 100a-100n, aggregation module 102a-102n, and an optional parental control modules 104a-104n. Although access module 36 is illustrated as including proxy module 100a-100n, aggregation modules 102a-102n, and parental control modules 104a-104n, it can be understood by one skilled in the art that one or more of such modules can be separate from access module 36, while capable of communicating with access module 36.

To simplify discussion of the various embodiments of the present invention, discussion will be made of a single proxy module 100, aggregation module 102, and parental control module 104, or similarly named modules in alternate embodiments of the present invention discussed hereinafter. It can be understood by one skilled in the art, however, that similar discussions as contained herein can be made for systems that include multiple proxy modules, aggregation modules, and parental control modules, where multiple modules are in a multi-module parallel and/or distributed topology resulting from network size, traffic load and configuration, or the like of the systems of the present invention.

Proxy module 100, in this illustrative embodiment, is adapted to control access to network 34 and consequently source module 32a-32n (FIG. 2). Proxy module 100 creates a single access point to network 34 through which all requests from receiver modules 40a-40n through aggregation module 102 are routed.

In communication with proxy module 100 is aggregation module 102 (FIG. 4). Aggregation module 102, in this illustrative embodiment, is configured to receive multiple requests for streaming media or other continuous media from receiver modules 40a-40n through data termination module 38. Upon receiving such requests, aggregation module 102 can combine or aggregate the requests into a single request to proxy module 100, thereby enabling proxy module 100 to retrieve the requested streaming media or other continuous media. Specifically, aggregation module 102 collects data indicative of the requests made by receiver modules 40a-40n and removes subsequent, redundant requests for the same real-time content. For instance, when a user requests the same real-time streaming or continuous feed twice, aggregation module 102 can identify the receipt of two requests, by comparing the address or URL of the request received from receiver modules 40a-40n, and not forward duplicate request.

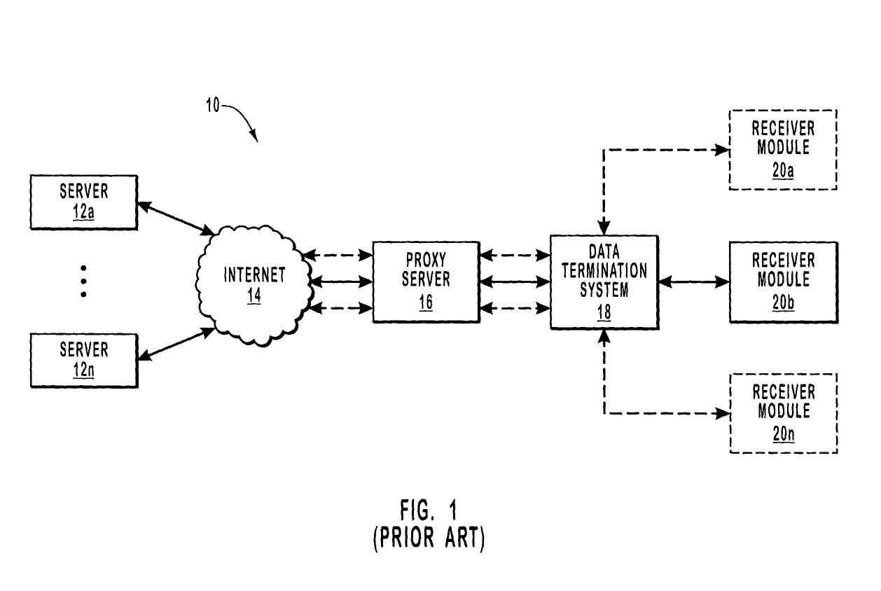

This is in contrast to current technology, where multiple requests for the same real-time streaming or continuous feed from multiple receiver modules result in multiple connections to the Internet through the proxy module. This results in the resources of the proxy server 16 (FIG. 1) being divided between multiple connections to Internet 14 and controlling the delivery of multiple received streams of media, such as streaming media from servers 12a-12n. Consequently, as each receiver module connects to the Internet and retrieves a copy of the requested streaming media, the connectivity rate or performance of each receiver module within the shared network is slowed. Additionally, although the effect may be minimal in some situations, the inclusion of multiple connections to Internet 14 increases the load applied to the Internet connection. Through use of aggregation module 102, the above described limitations or problems are overcome as aggregation module 102 aggregates requests for the same real-time streaming or continuous feed and delivers a single request to proxy module 100. This results in a single connection between proxy module 100 and network 34 for a particular real-time streaming or continuous feed.

In addition to the above, aggregation module 102, upon taking control of redundant requests can store a list of real-time streaming or continuous media requests and requesting receiver modules 40a-40n to be retrieved within a database. This database can be hierarchal, relational, flat, or other database structure, including related database management systems (not shown). Such database can utilize modular or fixed memory, magnetic storage disks, CDRW, optical storage media, or other mass storage for storing the information and data.

Aggregation module 102 is further configured to receive the requested streaming or continuous media and subsequently deliver the same to receiver modules 40a-40n. The delivered stream can be individual copies of the streaming or continuous media identified for specific receiver modules 40a-40n or as a single multicast broadcast to all receiver modules 40a-40n that are to receive such streaming or continuous media, as will be discussed in further detail hereinafter. This can be achieved, since aggregation module 102 tracks which receiver modules 40a-40n are delivering requests to receive the real-time streaming or continuous media or data. For example, in one configuration, aggregation module 102 analyzes the header information associated with a request for real-time streaming or continuous media or data to access the unique identifier for each receiver module 40a-40n. By storing a list of those unique identifiers for future access, aggregation module 102 can track which receiver modules 40a-40n are requesting real-time streaming or continuous media or data and which requested media or data each receiver module 40a-40n is to receive. Aggregation module 102 can determine from these requests the location, uniform resource locator (URL), Internet Protocol (IP) address, or other mechanism, of the data or content being requested. The content, as part of standard protocols is self-identifying. The aggregation module 102 can read this description and learn if it is appropriate for aggregation. It will “learn” this upon the first access and need not perform this process again for subsequent redundant requests. This operation is transparent to the proxy module 100, the receiver modules 40a-40n, and source modules 32a-32n involved.

Further, embodiments of aggregation module 102 (FIG. 4) are configured to convert any media received through the single access point or portal to a standardized or common media format or type. For example, in some situations, receiver modules 40a-40n are capable of displaying streaming or continuous media within a single format, such as, but not limited to Windows Media format. Other formats are known to those skilled in the art, such as but not limited to, Moving Picture Experts Group (MPEG) format, Real format, Audio Video Interleave (AVI) format, QuickTime format, Cinepaq, or the like. Aggregation module 102, therefore, can be configured to receive any format of streaming or continuous media and convert the same to Windows Media or other single format. It can be appreciated by one skilled in the art that aggregation module 102 can convert received streaming or continuous media into other formats. In this manner, the software and/or hardware used to display the retrieved media can be standardized and simplified, thereby creating stability, reliability, cost, and manufacturing efficiencies.

In communication with proxy module 100 is data termination module 38. Data termination module 38 is capable of manipulating data indicative of a viewer's request to access the media available on the Internet, etc. received from receiver modules 40a-40n. For instance, when receiver module 40a-40n is a set-top box, having Internet capabilities and associated cable modem hardware and/or software components, data termination module 104 can be adapted to convert the radio frequency data deliverable from receiver module 40a-40n into the appropriate data packets deliverable to access module 36. It can be appreciated by one skilled in the art, that data termination module 104 can deliver and manipulate signals from those receiver modules 40a-40n associated with a satellite system, or other systems known to those skilled in the art in light of the teaching contained herein.

As mentioned previously, access module 36 optionally includes a parental control module 104. Parental control module 104 is adapted to determine whether the media requested by receiver modules 40a-40n is to be delivered to such receiver modules 40a-40n. Consequently, parental control module 104, optionally in combination with aggregation module 102, data termination module 38, and receiver modules 40a-40n stores access or security data within a database, or some other storage media that defines the type of content or particular web sites from which media can be retrieved. Stated another way, such access or security defines the content or web sites from which receiver modules 40a-40n are prevented from requesting or receiving media, thereby restricting access to particular web sites and content therein.

In one configuration or embodiment, parental control module 104 accesses or includes a database 106 containing information about the access rights for each receiver module 40a-40n and/or registered user of the receiver module. Upon receiving a request for a web site or content from receiver modules 40a-40n, parental control module 104 can compare the rating, obtained from a third party service or prepared by the system operator, of the media or the uniform resource locator (URL) of the web site from which such media is obtained against the control information in database 106. Optionally, parental control module 104 can retrieve the content of the requested web page and subsequently compare the content rating and/or the web page's URL against the stored list of information or data within database 106. One skilled in the art can identify various other manners to control delivery of certain content or URL's to receiver modules 40a-40n.

In the event that parental control module 104 denies or restricts access to such media or data, aggregation module 102 denies access to and prevents delivery of the requested media or data. Optionally, parental control module 104, can display a notice to the viewer at receiver modules 40a-40n that identifies that the requested media or data is being restricted.

Generally, therefore, the embodiments of the present invention alleviate the above-recited problems by creating a single request for real-time streaming media to the Internet or other wide area network or local area network through which all requests from receiver modules 40a-40n are delivered. In this manner, a single connection is made to Internet 14, thereby more effectively utilizing the resources of proxy module 100 and the load applied to network 34, such as the Internet.

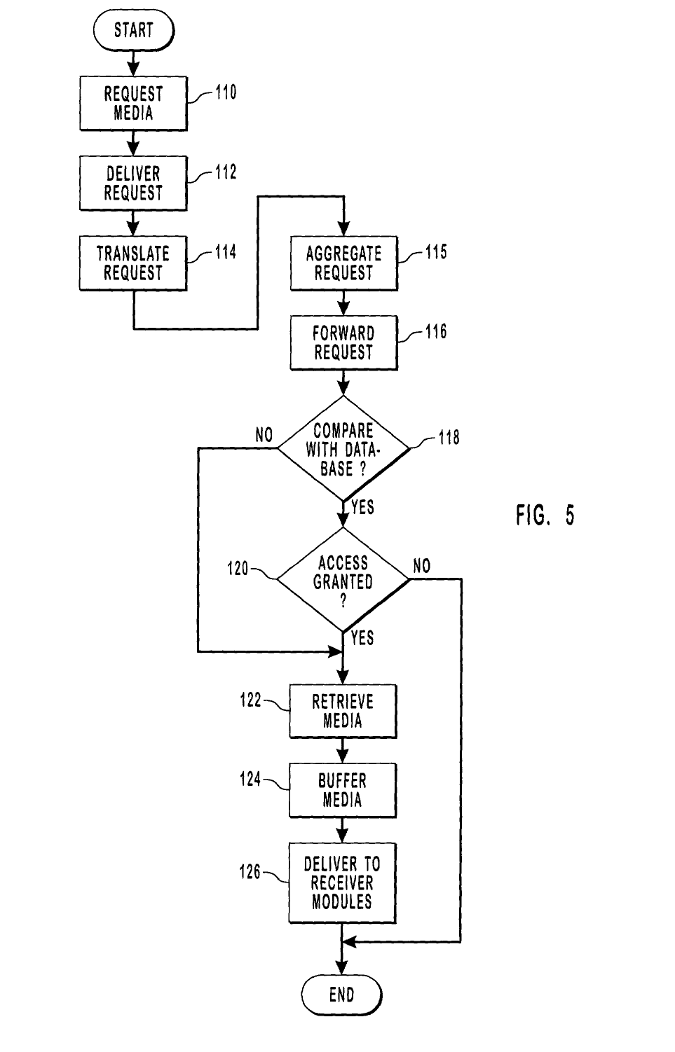

Referring now to FIG. 5, depicted is an illustrative manner by which requests are delivered to proxy module 100 and retrieved media is delivered to receiver modules 40a-40n. Initially, a request is made by receiver module 40a-40n to obtain media from one or more source modules 32a-32n (FIG. 2), as represented by block 110. For instance, a user at receiver module 40a-40n can utilize an input device, such as a remote control, keyboard, microphone, joysticks, or any other device capable of generating instructions to control the operation of receiver module 40a-40n, to input a request to receive certain media, such as streaming or continuous media.

In this illustrative configuration, let us assume that multiple users simultaneously request a real-time representation of the launch of the space shuttle. This may be the case when multiple users all simultaneously select to view the real-time feed of the launch or when multiple users periodically access or select to receive the real-time feed of the launch. In existing systems, as multiple users request to view the same real-time streaming or continuous media representation of the shuttle launch, the connection performance of each set top box or receiver accessing the media is dramatically reduced. In contrast, the embodiments of the present invention substantially maintain the connection rate of each user at substantially the same rate as when only one user has requested real-time streaming or continuous media. This is achieved by aggregation module 102 buffering a single instance of the space shuttle launch and delivering receiver module specific data packets to each receiver module 40a-40n through data termination module 38. Consequently, a perceived performance improvement is provided when one or more users requests to view the real-time streaming or continuous media feed.

With reference to FIGS. 4 and 5, as a request is generated by an input device and/or receiver module 40a, for instance, this request is delivered to data termination module 38, as represented by block 112. This request can include a designation of the particular URL from which the real-time streaming or continuous media is to be retrieved. Additionally, the request can include an identifier, such as in a header, which designates the particular receiver module 40a making the request for real-time streaming or continuous media. Optionally, the request can include a recitation of the access rights associated with the requesting receiver module 40a. One skilled in the art can identify other information that can be generated by an input device and/or receiver module 40a.

Following receipt of the request, data termination module 38 translates the request from, for example, a radio frequency (RF) signal to packetized data deliverable to proxy module 100 to obtain the requested media, as represented by block 114. Upon translating the data, data termination module 38 can forward the request to aggregation module 102, which removes redundant requests and tracks all receiver modules 40a-40n requesting the requested media, as represented by block 115. The aggregation module 102 then forwards the single request to proxy module 100, as represented by block 116. The proxy module 100 then uses a single connection to the Internet or network 34 to obtain the selected real-time streaming or continuous media.

Once proxy module 100 has received the request, if not previously completed by the aggregation module 102, proxy module 100 optionally compares the request against the database stored within parental control module 104, as represented by block 118. For instance, parental control module 104 can retrieve the information or data indicative of the access rights associated with the request and compare the same against the stored access information within database 106. In the event that a comparison is performed, such as when decision block 118 is in the affirmative, parental control module 104 identifies whether the specified media should be 110 retrieved from the Internet, as represented by decision block 120. In the event decision block 120 is in the affirmative, proxy module 100 retrieves the media from the Internet, as represented by block 122.

Following receipt of the media, in the case of real-time streaming media for instance, aggregation module 102 caches or buffers the retrieved media, as represented by block 124, in preparation for delivery to receiver module 40a by data termination module 38, as represented by block 126.

When multiple receiver modules 40a-40n request the same real-time streaming media, aggregation module 102 caches or buffers the single instance of the streaming or continuous media and delivers multiple separate instances of the same streaming or continuous media to the different receiver modules 40a-40n. Each instance of the streaming media includes the identifier received by aggregation module 102 that designates the particular receiver module 40a-40n to receive the media. Consequently, each receiver module 40a-40n can identify the particular instance of the streaming media and thereafter present the streaming media to a viewer.

According to one aspect of the present invention, when additional users access or request access to the real-time streaming or continuous media each user joins the real-time feed in progress, rather than at the commencement of the real-time feed.

One skilled in the art, in light of the teaching contained herein, can identify various other manners for requesting and receiving media. For example, when rating information for requested real-time streaming or continuous media is included within the delivered stream or continuous media, aggregation module 102 can request that parental control module 104 compare the retrieved media rating and/or URL or other identifier against rating information and/or URL or other identifier stored in database 106 to control access to the media, rather than comparing the request delivered through data termination module 38 to proxy module 100.

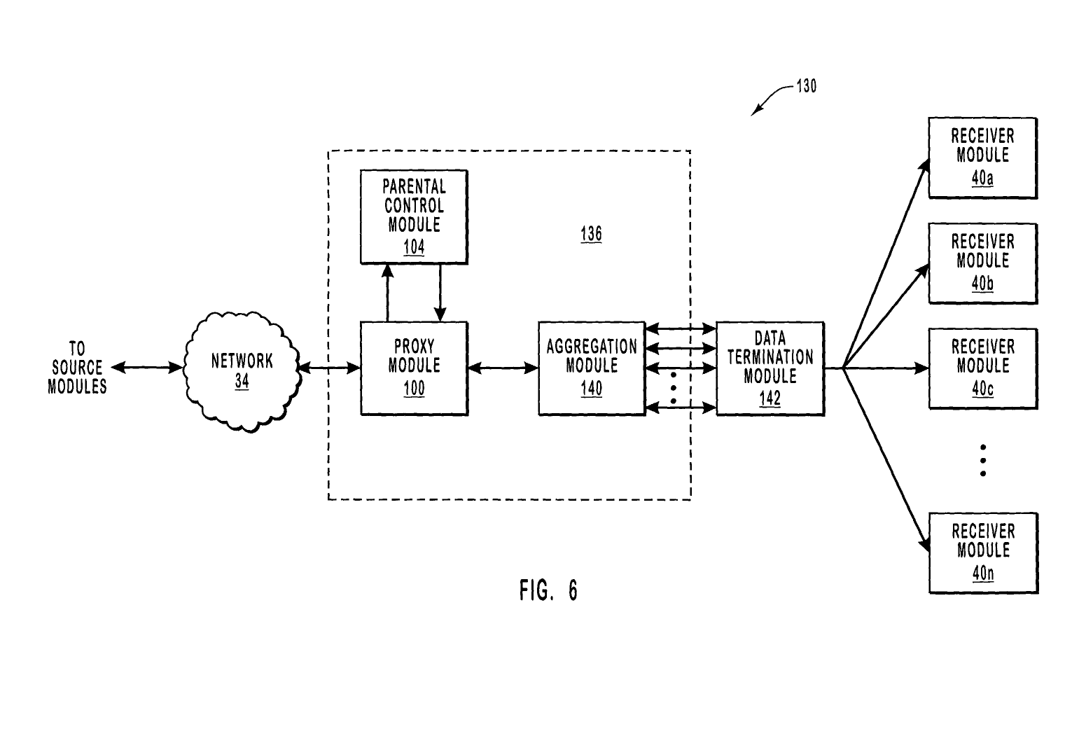

Referring now to FIG. 6, another embodiment of the present invention is depicted. The majority of the features previously discussed with respect to system 30 also apply to the embodiment of the present invention depicted in FIG. 6. The features that are not affected are identified with the same reference numbers as used in FIG. 4. Further, to simplify discussion of the various embodiments of the present invention, discussion will be made of a single proxy module, aggregation module, and parental control module; however, it can be understood by one skilled in the art, that a similar discussion can be made for system 130 that includes multiple proxy modules, aggregation modules, and parental control modules.

System 130 illustrates the particular embodiment where requests for streaming or other continuous media are aggregated and the subsequently received streaming media is delivered to multiple receiver modules 40a-40n through multicasting. The term “multicasting” references the delivery of one set of data packets to multiple receiving modules 40a-40n. One type of protocol for performing the desired “multicasting” is IP multicast. One skilled in the art can identify various other protocols, systems, methods, and modules to facilitate delivery of media to receiver modules 40a-40n.

In this particular configuration, an access module 136 facilitates communication between receiver modules 40a-40n and network 34. As shown, access module 136 includes a proxy module 100, a parental control module 104, and an aggregation module 140. In a similar manner to that described above with respect to FIG. 4, optionally parental control module 104, and aggregation module 140 can be seen as being separate physical systems or physically co-resident with proxy module 100. Whether parental control module 104 and aggregation module 140 are separate, physical systems or physically co-resident with proxy module 100 is dependent upon system topology, traffic, and business needs of the system operator.

Aggregation module 140, in this illustrative embodiment, is configured to aggregate to requests from receiver modules 40a-40n and deliver a single request to proxy module 100. Further, aggregation module 140 is adapted to receive the retrieved single stream of media from proxy module 100. Additionally, aggregation module 140 is configured to use heuristic methods, artificial intelligence, or the like, to determine when to deliver the requested real-time streaming or continuous media as a multicast broadcast or when to deliver the same in the manner described with respect to the embodiment of FIGS. 4 and 5. In this manner, aggregation module 140 can identify the method for delivering the requested real-time streaming or continuous media to limit the effects upon other receiver modules 40a-40n within the shared network that are not receiving the requested real-time streaming or continuous media.

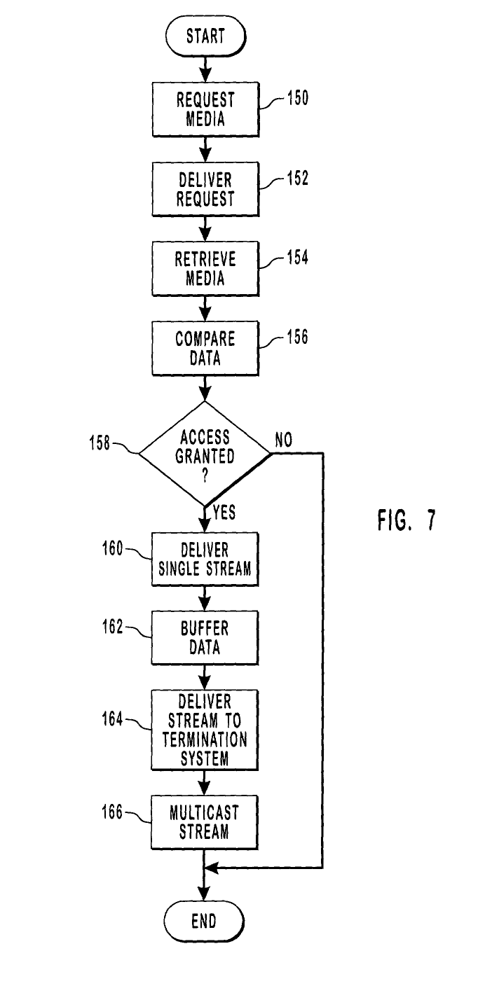

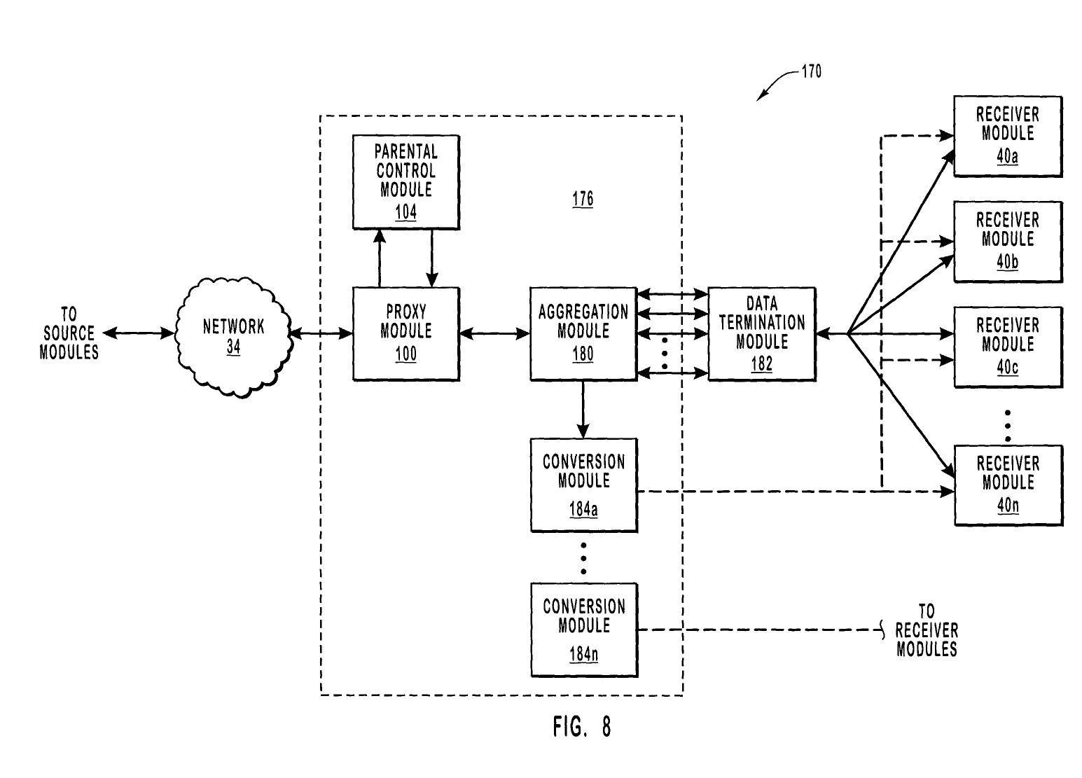

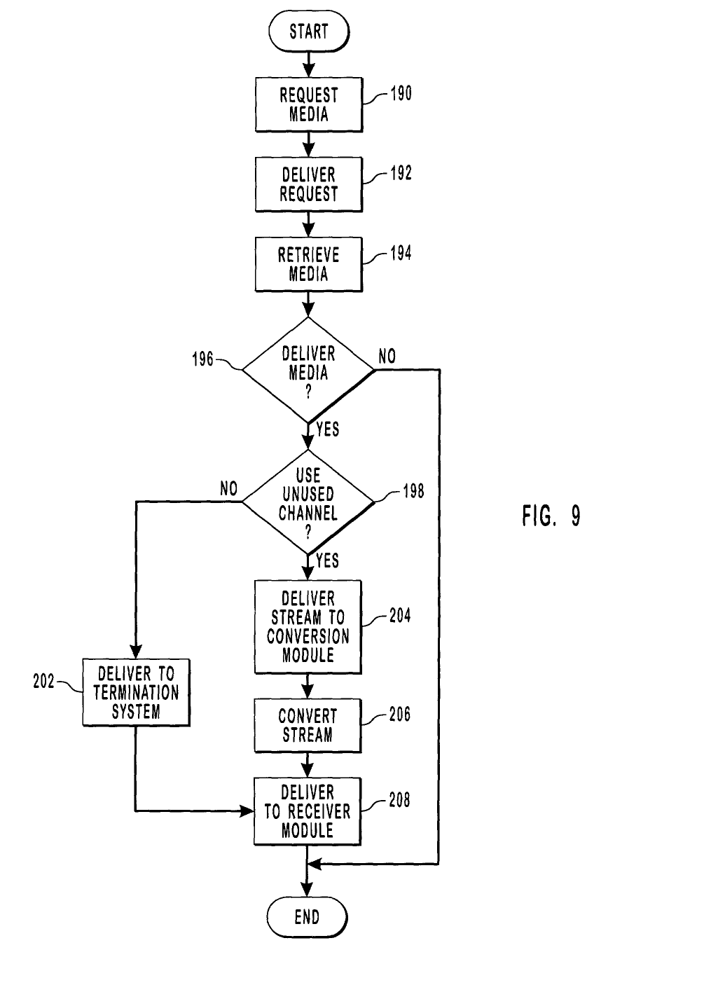

Depending upon the particular configuration of system 130, aggregation module 140 can identify when to deliver multiple streams of media, or to deliver a single stream of media for multicasting via the data termination module 142 to receiver modules 40a-40n. In one configuration, when two or more requests are made for the same real-time streaming or continuous media or data aggregation module 140 will deliver the retrieved media via a multicast delivery technique. In other configurations, heuristic methods, artificial intelligence, or the like can identify when to deliver the real-time streaming or continuous media or data to receiver modules 40a-40n. A discussion of heuristic methods, artificial intelligence, or the like is provided herein after with respect to the discussion of the embodiment of FIGS. 8 and 9 and applies to the embodiment of FIGS. 6 and 7.

As illustrated, unidirectional multicast communication is illustrated between receiver modules 140a-140n and data termination module 142. One skilled in the art can understand, however, that periodic, continuous, or sporadic bi-directional communication can occur between receiver modules 40a-40n and data termination module 142, such as that illustrated in FIG. 4.

In application of the above, illustratively, when a real-time presentation of a shuttle launch is available via the Internet and multiple receiver modules 40a-40n request the real-time presentation, aggregation module 140 identifies the number of receiver modules 40a-40n requesting the shuttle launch. Further, aggregation module 140 uses appropriate methods or rules to determine whether the number of requests received by aggregation module 140 is greater than a defined maximum number of requests that maintains the connection rate of the shared network at a preferred level, i.e., in one embodiment, when the number of requests is equal to or greater than two requests. In the event that the number of requests exceeds this maximum number, aggregation module 140 changes the manner by which aggregation module 140 delivers the requested real-time streaming or continuous media.

Specifically, aggregation module 140 changes from delivering data packets addressed specifically to each receiver module 40a-40n via an address identifier located within each data packet's header to delivering the same data packets, i.e., shared data packets to each receiver module 40a-40n. Consequently, each receiver module 40a-40n perceives its connection as being substantially the same as before each receiver module 40a-40n requested the streaming media.

According to another aspect of the illustrative embodiment of FIG. 6, aggregation module 140 can include a network operator or administrator that tracks the activities of receiver modules 40a-40n and identifies frequently requested real-time streaming or continuous media, such as annual fashion shows, sporting events, music events, political events, or the like. Further, the network operator or administrator can identify upcoming events that are traditionally requested by a large number of viewers. In either case, the network operator or administrator causes aggregation module 140 to deliver the real-time streaming or continuous media to all receiver modules 40a-40n requesting such media via multicast process, such as IP multicast, instead of aggregation module 140 delivering multiple streams of media to data termination module 142.

One skilled in the art can identify various other configurations of system 130 that are capable of performing the desired functions. For example, the functionality associated with aggregation module 140 can be merged into the proxy module 100. Similarly, the functionality of proxy module 100, aggregation module 140, and/or parental control module 104 can be merged into a single module, that includes the functionality of proxy module 100, aggregation module 140, and/or parental control module 104. Additionally, aggregation module 140 can be configured to convert received media into a standardized or common media type, as described above.

Referring now to FIG. 7, depicted is a flow diagram of one illustrative manner or method for delivering media to one or more receiver modules 40a-40n. As shown, a request is made by receiver module 40a-40n to obtain media from one or more source modules 32a-32n (FIG. 2), as represented by block 150. For instance, a user can utilize an input device, to input a request to receive certain programming or data, such as streaming media, or the like.

As a request is generated by an input device and/or receiver module 40a, for instance, this request is delivered to data termination module 142 and subsequently to proxy module 100 through aggregation module 140, as represented by block 152. Once proxy module 100 has received the request, proxy module 100 can retrieve the media from the Internet, as represented by block 154.

Following receipt of the media at proxy module 100, in the case of real-time streaming media for instance, aggregation module 140 can compare the rating (provided by a third party service or the system operator), uniform resource locator (URL), or other pertinent information known by one skilled in the art that identifies the source of the received media against the database associated with parental control module 104, as represented by block 156. In the event that access is granted, i.e., decision block 158 is in the affirmative, aggregation module 140 adds the associated receiver to the list of receivers for the stream.

Upon affirmative grant of permission for access, aggregation module 140, either automatically or in accordance with the control of an administrator or network operator, caches or buffers the retrieved media, as represented by block 162, in preparation for delivery of a single instance of the real-time streaming or continuous media to data termination module 142, as represented by block 164. The aggregation module 140 prepares the real-time streaming or continuous media for delivery to receiver modules 40a-40n by data termination module 142 through a multicast process and informs the requesting receivers of the stream identification for their stream, as represented by block 166. In this manner, access module 136 controls the delivery of requested media to substantially reduce the adverse effects upon those receiver modules 40a-40n that access the Internet, but are not receiving the real-time streaming or continuous media.

One skilled in the art, in light of the teaching contained herein, can identify various other manners for requesting and receiving media. For example, aggregation module 140 can compare data representative of the request against the database associated with parental control module 104 to control access to the media, rather than comparing the retrieved media. According to another configuration, aggregation module 140 can deliver media by the manner described with respect to FIGS. 4 and 5 until aggregation module 140 determines that it is alternatively possible to deliver the media via a multicast process where each receiver module 40a-40n receives shared data packets. Such a determination can be based upon financial considerations, connectivity considerations, hardware and/or software considerations, combinations thereof, or other considerations known to one skilled in the art in light of the teaching contained herein.

FIG. 8 illustrates another embodiment of a system facilitating delivery of real-time streaming or continuous media to one or more set top boxes or receivers. The majority of the features previously discussed with respect to systems 30 and 130 also apply to system 170. Further, to simplify discussion of the various embodiments of the present invention, discussion will be made of a single proxy module, aggregation module, and parental control module; however, it can be understood by one skilled in the art, that a similar discussion can be made for system 170 that includes multiple proxy modules, aggregation modules, and parental control modules.

System 170 illustrates the particular embodiment where each receiver module 40a-40n can receive real-time streaming or continuous media in the manner discussed with respect to FIGS. 4-7, while optionally delivering requested real-time streaming or continuous media to receiver modules 40a-40n through an unused audio or video channel associated with the cable or satellite system. Delivering the requested real-time streaming or continuous media upon an unused audio or video channel increases connection performance for other receiver modules 40a-40n within the shared network, because the large bandwidth required to deliver the requested streaming or continuous media from the data termination module 182 to receiver modules 40a-40n and is released for other uses.

In this particular configuration, system 170 includes an access module 176 that controls delivery of requested real-time streaming or continuous media to receiver modules 40a-40n. As shown, access module 176 can include a proxy module 100, a parental control module 104, an aggregation module 180, and optional conversion module 184a-184n. The various modules forming access module 176 can be incorporated within access module 176 or optionally remote therefrom by accessible by access module 176 or other modules therein. For instance, parental control module 104 can be remote from access module 176 but accessible by proxy module 100 and/or other modules of access module 176. Although conversion module 184a-184n is shown incorporated within access module 176, it can be understood by one skilled in the art that conversion module 184a-184n can be separate from access module 176, while communicating with access module 176.

Aggregation module 180, in this illustrative embodiment, is configured to buffer the single stream of requested media from proxy module 100 in preparation for delivering a single stream of the requested media to data termination module 182. Additionally, aggregation module 180 identifies particular real-time streaming or continuous media that is requested by a large number of receiver modules 40a-40n. In such a case, aggregation module 180 can select to delivery the real-time streaming or continuous media by way of an unused video channel and/or audio channel. The determination of whether to deliver the real-time streaming or continuous media, as a Moving Picture Experts Group (MPEG) stream upon an unused digital video channel and/or audio channel, or converted for display on an unused analog channel is performed through a heuristic process, artificial intelligence, or the like or manually by way of an administrator or network operator. These decisions would be made upon system type, configuration, and available resources at the time.

Illustratively, such heuristic methods, artificial intelligence, or the like can identify when a number of requests received from receiver modules 40a-40n is sufficient to cause a reduction in the connection performance of substantially all receiver modules 40a-40n connected to the Internet through access module 176. In such a case, aggregation module 180 can cache or buffer the requested media, such as streaming media, and begin to deliver to receiver modules 40a-40n using a multicasting process rather than by delivering individual streams to each receiver.

Illustratively, such above-defined determination can be made through heuristic rules and parameters that initiate a change in the delivery method or manner when the “load” applied to the shared network by delivering the real-time streaming or continuous media either by receiver specific streams or a multicast broadcast reduces the connection performance by a defined percentage. Another rule can define that when the number of requests for specific real-time streaming or continuous media exceeds a defined quantity, such as greater than 2 requests, aggregation module 180 begins to delivery the real-time streaming or continuous media upon an unused audio and/or video channel of the cable or satellite system. Various other rules, methods, and manners to achieve a change in the delivery method or manner are known to those skilled in the art in light of the teaching contained herein.

As mentioned above, system 170 includes conversion module 184a-184n. Reference will be made to the operation of conversion module 184a; however, a similar discussion can be made for any conversion module 184a-184n. Conversion module 184a is adapted to receive real-time streaming or continuous media from aggregation module 180 and deliver the same to receiver modules 40a-40n upon an unused audio and/or video channel. Consequently, conversion module 184a is configured to translate the streaming media into an analog television format, a digital television format, audio or text formats, or the like. Therefore, conversion module 184a manipulates the streaming media into a form capable of being delivered upon a spare system channel as an MPEG signal, for instance, distributed to receiver modules 40a-40n. One skilled in the art, in light of the teaching contained herein, can identify other formats to which the streaming media is converted to be distributed to receiver modules 40a-40n, including, but not limited to MPEG 1, MPEG2, MPEG3 (audio), analog video, such as NTSC, PAL and SECAM, SCA audio channels, and text delivered through line 21. Generally, any conversion formats can be utilized, whether known or developed in the future, so long as such formats are selected by the operator, chosen to accommodate system requirements, combinations thereof, or the like.

Alternatively, SCA audio channels and text delivered through line 21 can be merged with an existing television channel for recovery at the receiver as discussed above.

In addition to delivering the newly formatted media to receiver modules 40a-40n, via conversion module 184a, aggregation module 180 can deliver an HTML page or some other signal to receiver module 40a-40n to inform viewers at receiver modules 40a-40n of the availability of the requested streaming media upon a particular audio and/or video channel accessible through receiver module 40a-40n. For instance, in the event that multiple receiver modules 40a-40n request a streaming media representation of the launch of the space shuttle, aggregation module 180 can generate a notice and deliver the same to receiver modules 40a-40n that identify a programming channel, say channel 250 for instance, upon which the launch of the space shuttle is displayed. Optionally, aggregation module 180 can automatically cause receiver modules 40a-40n to tune from the currently viewed channel to the channel displaying the launch, i.e., channel 250 in this example. The automatic switching of receiver module 40a-40n can occur after a short period of time, such as a few seconds, from the display of the notice to the viewer or can occur substantially simultaneously.

By so doing, proxy module 100, aggregation module 180 and/or conversion module 184a limit the potential for a perceived slowdown in the connection speed for each receiver module 40a-40n connected to the shared network of system 170. Specifically, since the bandwidth used to display the launch of the space shuttle is removed from the communication line connection used by receiver modules 40a-40n to access network 34, i.e., the Internet, and placed upon an MPEG stream or other data stream separate from the above-referenced communication line connection, the connectivity rate of receiver modules 40a-40n can be increased rather than decreased. This is an advance over existing technologies that reduce the connection rate of substantially all receiver modules 40a-40n when streaming media is delivered to one or more of the receiver modules 40a-40n.

According to another aspect of the illustrative embodiment of FIG. 8, aggregation module 180 can automatically determine when to transfer the requested streaming media to an unused video and/or audio channel, such as through heuristic methods, artificial intelligence, or the like as described herein and known to those skilled in the art. Alternatively, a network operator or administrator can track the activities of receiver modules 40a-40n and identify streaming media to be delivered upon an unused audio and/or video channel.

With reference now to FIG. 9, a flow diagram illustrating a manner or method for delivering media to one or more receiver modules 40a-40n using system 170 of FIG. 9 is depicted. As shown, a request is made by receiver module 40a-40n to obtain media from one or more source modules 32a-32n (FIG. 2), as represented by block 190. For instance, a user can utilize an input device, to input a request to receive certain programming or data, such as streaming media, or the like.

As a request is generated by an input device and/or receiver module 40a, for instance, this request is delivered to data termination module 182, through aggregation module 180, and subsequently to proxy module 100 if the request is new, as represented by block 192. Once proxy module 100 has received the request, proxy module 100 can retrieve the media from the Internet, as represented by block 194. If the request is not new, the stream is already being managed by aggregation module 180.

Upon receiving the media from the Internet via proxy module 100, aggregation module 180 in combination with parental control module 104 determines whether to deliver the requested media to the individual receiver module 40a-40n, is represented by decision block 196. In the event that the determination is in the affirmative aggregation module 180 adds the receiver to the list, buffers the retrieved media, and determines to either deliver the media to receiver module 40a-40n along the communication line connection established between receiver module 40a-40n via data termination module 182, as represented by block 202, or via an unused audio and/or video channel of the cable or satellite system, as represented by decision block 198 being in the affirmative. When data termination module 182 is to be used, following receipt of the stream of real-time streaming or continuous media, data termination module 182 translates media and delivers the media, such as by using a multicast process, to each receiver module 40a-40n, as represented by block 208. In this manner, access module 176 controls the delivery of requested real-time streaming or continuous media to substantially reduce the adverse affects upon those receiver modules 40a-40n that access the Internet, but are not receiving the real-time streaming or continuous media.

Alternatively, in the event decision block 198 is in the affirmative, aggregation module 180 delivers the received media to conversion module 184a, as represented by block 204. Consequently, conversion module 184a converts the real-time streaming or continuous media into a format deliverable upon an unused audio and/or video channel of system 170, as represented by block 206. Thereafter, conversion module 184a delivers the real-time streaming or continuous media to receiver modules 40a-40n upon such an unused audio and/or video channel, as represented by block 208.

Although reference is made to delivering the media to receiver modules 40a-40n with reference to block 208, the particular delivery manner is different depending upon whether data termination module 182 or conversion module 184a delivers the media. For simplicity, only one block represents both delivery methods; however, one skilled in the art can identify that two or more blocks can represent the different delivery methods and manners.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system having a plurality of receivers and at least one aggregation module, a method for providing real-time streaming media from a wide area network to the plurality of set top boxes, the method comprising:
(a) receiving at at least one aggregation module a request for real-time streaming media accessible via a wide area network from each of a plurality of receivers, each request comprising an identifier representative of the receiver making the request;
(b) using the at least one aggregation module, creating a single communication connection between at least one proxy module and the wide area network from which a single copy of the real-time streaming media is retrievable;
(c) buffering the single copy of the real-time streaming media at the at least one aggregation module; and
(d) using the buffered single copy of the real-time streaming media, delivering separate instances of the streaming media to the plurality of receivers.

2. A method as recited in claim 1, wherein the at least one proxy module is remote from at least one of the plurality of receivers.

3. A method as recited in claim 1, further comprising delivering the cached single copy of the streaming media to the at least one aggregation module.

4. A method as recited in claim 3, further comprising delivering separate instances of the streaming media to the plurality of receivers by the at least one aggregation module.

5. A method as recited in claim 1, further comprising selecting a format for delivering the streaming media to the plurality of receivers.

6. A method as recited in claim 1, further comprising delivering the streaming media to each of the plurality of receivers by a multicast broadcast.

7. A method as recited in claim 1, further comprising converting the single copy of the streaming media into a standardized format.

8. A method as recited in claim 1, wherein the system comprises a cable system having a plurality of used channels for display broadcast programming to the plurality of receivers and a plurality of unused channels.

9. A method as recited in claim 8, further comprising identifying when to delivery the single copy of the real-time streaming media to the plurality of receivers by at least one of the plurality of unused channels.

10. A computer program product for implementing, in a system having a plurality of receivers, a method for providing streaming media from a wide area network to the plurality of receivers, the computer program product comprising:
a computer readable medium carrying computer-executable instructions for implementing the method, wherein the computer-executable instructions comprise the act of:
receiving at the aggregation module a request for streaming media accessible via a wide area network from each of a plurality of receivers, each request comprising an identifier representative of the receiver making the request;
using the aggregation module, creating a single communication connection between the proxy module and the wide area network from which a single copy of the streaming media is retrievable;
buffering the single copy of the streaming media at the aggregation module; and
using the buffered single copy of the streaming media, delivering separate instances of the streaming media to the plurality of receivers.

11. In a system having a plurality of receivers and at least one aggregation module, a method for providing streaming media from a network to the plurality of receivers, the method comprising:
(a) receiving at an aggregation module a request for streaming media accessible via a network from each of a plurality of receivers;
(b) using a proxy module in communication with the aggregation module, retrieving a copy of the streaming media from the network;
(c) delivering the single stream to the aggregation module
(d) buffering the copy of the streaming media at the aggregation module; and
(e) delivering the stream of the buffered streaming media to a termination system for transmission to each of the plurality of receivers, wherein each of the plurality of receivers receives substantially the same packets of the buffered streaming media.

12. A method as recited in claim 11, wherein the network is selected from the group consisting of a wide area network and a local area network.

13. A method as recited in claim 12, wherein the network is the Internet.

14. A method as recited in claim 13, further comprising delivering the buffered single copy of the streaming media from the aggregation module to the termination system.

15. A method as recited in claim 11, further comprising selecting a format for delivering the streaming media to each of the plurality of receivers.

16. A method as recited in claim 15, wherein further comprising delivering a plurality of instances of the streaming media to the plurality of receivers.

17. A method as recited in claim 15, further comprising delivering a single instance of the streaming media to each of the plurality of receivers.

18. A method as recited in claim 15, wherein each of the plurality of receivers includes at least one channel for receiving programming and at least one unused channel in the associated system.

19. A method as recited in claim 18, wherein the system is a cable system, a television system, or a satellite system.

20. A method as recited in claim 11, further comprising converting the copy of the streaming media into a standardized format.

21. A method as recited in claim 11, wherein the request comprises at least one addressing mechanism for network resources and at least one identifier representative of a requesting receiver of the plurality of receivers delivering the request to the aggregation module.

22. A method as recited in claim 21, further comprising comparing a rating associated with the at least one addressing mechanism for network resources against a stored list of ratings to determine whether content associated with the at least one addressing mechanism for network resources is to be delivered to the requesting receiver.

23. A method as recited in claim 22, wherein the at least one addressing mechanism for network resources comprises a uniform resource locator.

24. A method as recited in claim 22, wherein comparing occurs upon the proxy module delivering content retrieved from the network to the aggregation module.

25. A computer program product for implementing, in a system having a plurality of receivers and at least one aggregation module, a method for providing streaming media from a wide area network to the plurality of receivers, the computer program product comprising:
a computer readable medium carrying computer-executable instructions for implementing the method, wherein the computer-executable instructions comprise:
at an aggregation module, program code means for receiving a request for streaming media accessible via a proxy module from each of a plurality of receivers;
using the proxy module, program code means for retrieving a single copy of the streaming media from a network accessible to the proxy module;
program code means for buffering the single copy of the streaming media at the aggregation module; and
program code means for delivering the single stream of the buffered streaming media to a termination system for transmission to each of the plurality of receivers, wherein each of the plurality of receivers receives substantially the same packet of the single stream of the buffered streaming media.

26. A computer program product as recited in claim 25, wherein the computer-executed instructions further comprise program code means for generating each request from each of the plurality of receivers using an input device.

27. A computer program product as recited in claim 25, wherein the computer-executed instructions further comprise program code means for delivering the buffered single copy of the streaming media from the aggregation module.

28. A computer program product as recited in claim 27, wherein the computer-executed instructions further comprise program code means for delivering the cached single copy of the streaming media from the aggregation module to the termination system.

29. A computer program product as recited in claim 27, wherein the computer-executed instructions further comprise program code means for selecting a format for delivering the streaming media to each of the plurality of receivers.

30. A computer program product as recited in claim 27, wherein the computer-executed instructions further comprise program code means for converting the single copy of the streaming media into a standardized format.

31. In a system having a plurality of receivers and a proxy module, each of the plurality of receivers being capable of displaying a plurality of video channels, a method for providing streaming media from a wide area network to the plurality of receivers, the method comprising the acts of:
(a) receiving a request for streaming media accessible via a wide or local area network from one of the plurality of receivers;
(b) in response to retrieving the streaming media from the wide or local area network, preparing the streaming media requested by at least one of the plurality of receivers for delivery to a video channel of the plurality of video channels; and
(c) delivering the prepared streaming video to the receiver upon the video channel of the plurality of video channels.

32. A method as recited in claim 31, wherein the request comprises at least one of an identifier representative of the receiver delivering the request and a uniform resource locator identifying a source of the streaming media.

33. A method as recited in claim 31, further comprising the act of retrieving the streaming media from the wide area network via an access system.

34. A method as recited in claim 33, wherein the access system comprises a proxy module, a parental control module, and an aggregation module.

35. A method as recited in claim 34, wherein the act of preparing the streaming media comprises:
(a) an act of retrieving the streaming media, by the proxy module, managed by the aggregation module, from the wide area network;
(b) an act of delivering the streaming media to a conversion module; and
(c) an act of translating the streaming media into a format capable of being delivered to the receiver upon the video channel.

36. A method as recited in claim 35, further comprising an act of selecting a format to deliver the streaming media to the receiver, the formats being selected from the group consisting of analog format, digital format and text format.

37. A method as recited in claim 35, further comprising an act of controlling delivery of the streaming media based upon information stored within at least one of the parental control module, the receiver, the proxy module, the aggregation module, and a data termination module.

38. A system for displaying media retrieved from a network to a plurality of receivers, the system comprising:
(a) a source module storing media;
(b) a plurality of receivers communicating with the source module via a network, each of the plurality of receivers being configured to generate a request and receive the media from the source module at a first connection rate; and
(c) an access module communicating with the plurality of receivers and the source module, the access module being configured to receive the request for media and deliver the requested media in a format selected by the access module based upon changes to the first connection rate as media is delivered to two or more of the plurality of receivers.

39. A system as recited in claim 38, wherein the source module comprises a server.

40. A system as recited in claim 38, wherein the access module comprises at least one of each of a proxy module, a parental control module, and an aggregation module.

41. A system as recited in claim 40, wherein the proxy module is configured to retrieve media requested by at least one of the plurality of receivers.

42. A system as recited in claim 41, wherein the aggregation module is configured to convert the retrieved media into a standardized format.

43. A system as recited in claim 38, wherein the aggregation module is configured to deliver the requested media in a format based upon changes to the first connection rate.

44. A system as recited in claim 43, wherein the aggregation module delivers multiple instances of the requested media to the plurality of receivers, each of the plurality of receivers receiving a separate instance of the media.

45. A system as recited in claim 44, wherein the aggregation module delivers a single instance of the requested media to the plurality of receivers, each of the plurality of receivers receiving the single instance of the media.

46. A system as recited in claim 45, wherein each of the plurality of receivers is capable of displaying a plurality of video channels, at least one of the plurality of video channels being unused.

47. A system as recited in claim 46, wherein the aggregation module delivers a single instance of the requested media to the plurality of receivers on the unused video channel.
